(19) United States
(12) Patent Application Publication
(10) Pub. No.: US 2016/0261599 A1
(43) Pub. Date: Sep. 8, 2016

(54) DIGITAL MANAGEMENT OF CONTENT ASSETS IN THE CLOUD

(71) Applicant: Sony Computer Entertainment America LLC, San Mateo, CA (US)

(72) Inventors: David Perry, Dana Point, CA (US); Takuhito Tsujimoto, San Mateo, CA (US); Paul Schultz, Saratoga, CA (US)

(21) Appl. No.: 14/640,588

(22) Filed: Mar. 6, 2015

(51) Int. Cl. H04L 29/06; G06Q 20/08; H04L 29/08

(52) U.S. Cl. CPC H04L 63/101; H04L 67/1097; G06Q 20/0855

(57) ABSTRACT

Aspects of the present disclosure relate to systems and methods for sharing assets of applications between users. A user may share an application or certain features within an application via the transfer of application rights between users. The providing user may be restricted from accessing that application or the application features transferred until the borrowing user has either relinquished the rights to the application or until a certain amount of time has passed.

### FIELD

The present disclosure relates to digital asset management. In particular, aspects of the present disclosure relate to systems and methods for transferring selected rights to digital assets, including, but not limited to, access, utilization, and field of use, between users.

### BACKGROUND

Digital rights management (DRM) is a class of technologies intended to control the use of digital content and devices after sale. Some DRM technologies, often known as “first generation DRM” are intended to control copying of, e.g., software and/or digital data. Other technologies, sometimes called “second-generation DRM” are designed to control executing, viewing, copying, printing, and altering of works or devices.

With the increasing prevalence of entirely digital application stores and the reliance on digital rights management (DRM) protection, the ability of users to share applications, including physical copies of applications as well as in-application data, has suffered. If a user wishes to recommend an application or share a particular feature in an application, it is less and less likely that a user would simply be able to hand over a physical copy of the application to another user and have that application function properly.

In the case of digital downloads, it would be cumbersome for one user to send an application to another user over a network, especially considering the limitations in the quality and bandwidth of networks established or used during the transfer of data, as well as the size (upwards of 30 GB) of some applications. Digital application stores, however, are able to work around these limitations due to dedicated infrastructure. Additionally, a digital application store is able to provide any software patches and updates required to execute an application on a user's device, whereas an application transferred between two users may not include all of the necessary data required to function with ideal specifications.

Accordingly, there is a need in the art to find alternative means for users to recommend, sample, and share application data with other users. This is true of sharing both the application itself as well as certain features within the application. It is within this context that aspects of the present disclosure arise.

### SUMMARY

In accordance with certain implementations of the present disclosure, a method for sharing digital assets on client devices configured to operate on a network may include providing a user with a list of assets that can be borrowed from a providing user. A requesting user may then be able to request the use of an asset that can be borrowed. The requesting user may then receive certain rights, such as access to an application or application features, from the providing user. Alternative embodiments provide a method in which a providing user may grant asset rights to another user without first receiving a request.

In accordance with certain implementations of the present disclosure, a computing system may include at least one processor unit, and at least one memory unit coupled to the at least one processor unit. The at least one processor unit and the at least one memory unit may be configured to perform a method. The method may include sharing digital assets on a client devices configured to operate on a network, which may include providing a user with a list of assets that can be borrowed from a providing user. A requesting user may then be able to request the use of an asset that can be borrowed. The requesting user may then receive certain rights, such as access to an application or application features, from the providing user. Alternative embodiments provide a method in which a providing user may grant asset rights to another user without first receiving a request.

In accordance with certain implementations of the present disclosure, a non-transitory computer readable medium may computer readable instructions embodied therein. The computer readable instructions may be configured to implement a method when executed. The method may include sharing assets on a client devices configured to operate on a network, which may include providing a user with a list of assets that can be borrowed from a providing user. A requesting user may then be able to request the use of an asset that can be borrowed. The requesting user may then receive certain rights, such as access to an application or application features, from the providing user. Alternative embodiments provide a method in which a providing user may grant asset rights to another user without first receiving a request.

### BRIEF DESCRIPTION OF THE DRAWINGS

The teachings of the present disclosure can be readily understood by considering the following detailed description in conjunction with the accompanying drawings, in which:

FIG. 1 is a flow diagram of an example asset management technique between the client devices in accordance with certain aspects of the present disclosure.

FIG. 2 is a block diagram of an example system in accordance with certain aspects of the present disclosure.

FIG. 3 is a flow diagram of an example asset management technique from the providing user side in accordance with certain aspects of the present disclosure.

FIG. 4 is a flow diagram of an example asset management technique from the requesting user side in accordance with certain aspects of the present disclosure.

FIG. 5 illustrates a method for processing transfer of rights to digital assents on an intermediary server according to aspects of the present disclosure.

### DETAILED DESCRIPTION

Although the following detailed description contains many specific details for the purposes of illustration, anyone of ordinary skill in the art will appreciate that many variations and alterations to the following details are within the scope of the invention. Accordingly, the illustrative implementations of the present disclosure described below are set forth without any loss of generality to, and without imposing limitations upon, the claimed invention.

### Introduction

Aspects of the present disclosure relate to systems and methods for sharing application assets between client devices configured to operate on a network.

In accordance with certain aspects, a client device configured to operate on a network may provide a user with a list of one or more digital assets that can be borrowed from a providing user. The may then be able to request the use of an asset that can be borrowed from a providing user. The user may then receive certain rights, such as access to an application or application features, from the providing user. Alternative embodiments provide a method in which a providing user may grant asset rights to another user without first receiving a request.

Implementation Details

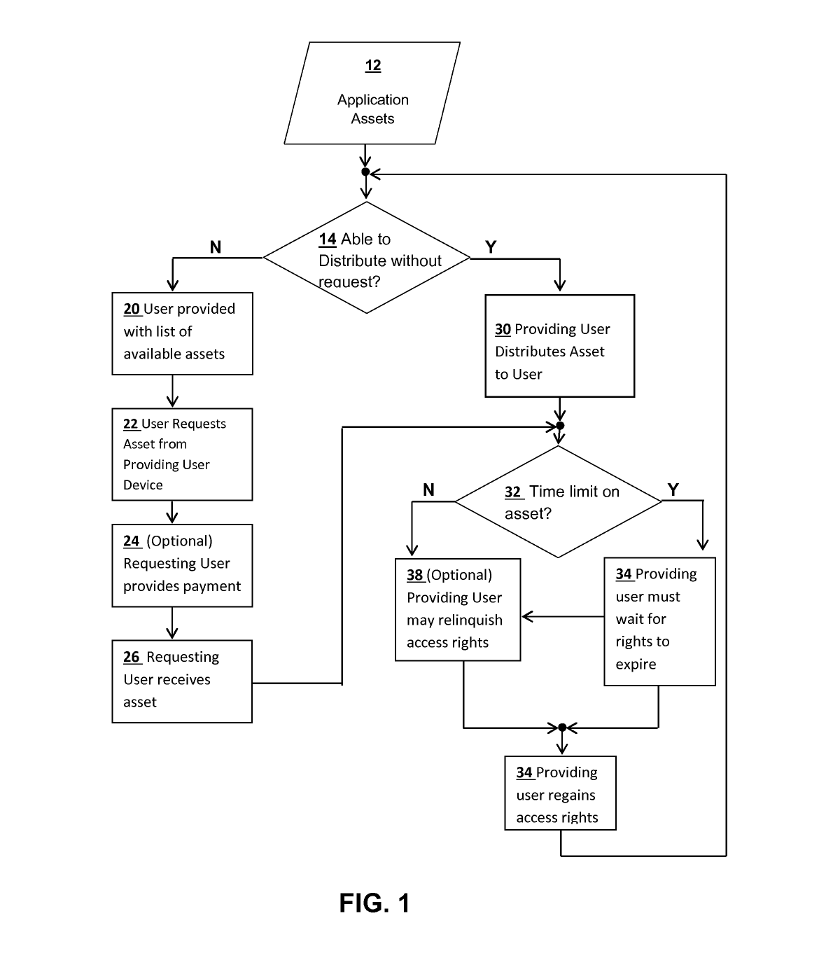

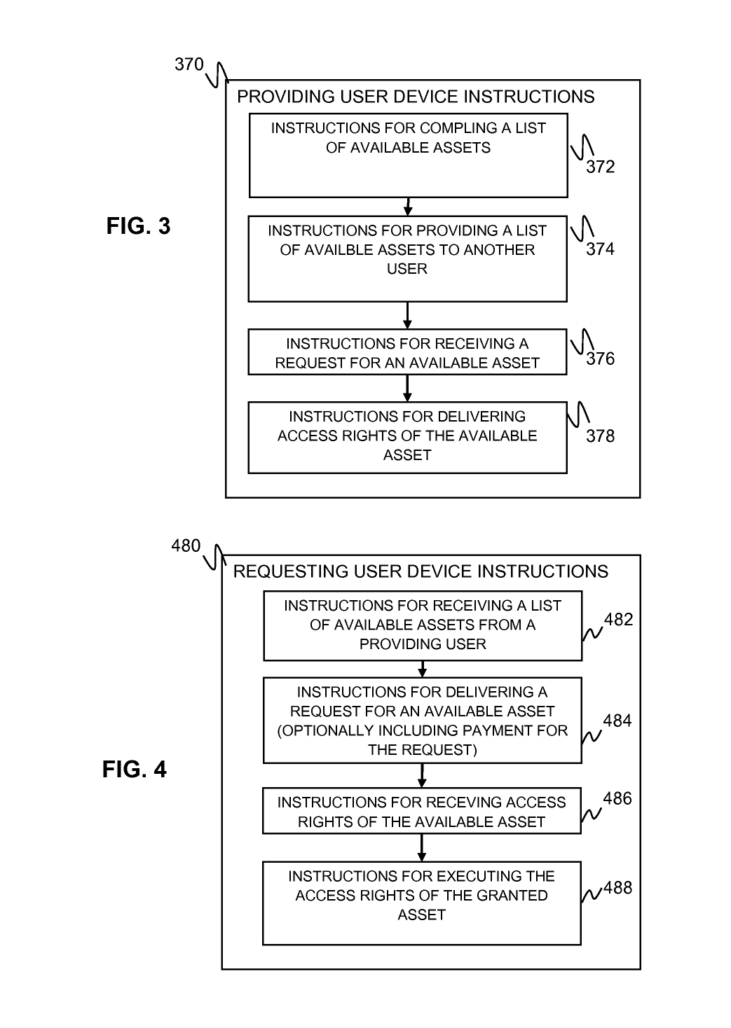

Turning now to FIG. 1, an illustrative example is provided of how a digital asset may be provided to a client device in response to a request received from a requesting user client device. In particular, FIG. 1 depicts an example process flow for providing a client device with an available application asset, in accordance with certain implementations of the present disclosure. It is noted that the example method of providing an application asset in FIG. 1 may have one or more aspects in common with the methods indicated in FIGS. 3 and 4. It is also important to note that the example of FIG. 1 is only a simplified example for purposes illustrating only certain aspects of how an application asset may be provided in accordance with the present disclosure.

At the outset, it is important to note that in this example, an application asset is provided to a client device that is requesting an asset from a providing user. In this example, as shown in FIG. 1, the digital asset 26 is provided in response to a request for said asset from a providing user 22 that is received by the providing user's client device. In alternative implementations, the providing user may be able to simply grant another user the rights to use a certain digital asset 30 by choosing a user to which the asset is delivered. However, in alternative implementations, an asset may be sent or provided under other circumstances. For example, an alternative embodiment may provide a method by which a granted asset access rights is received from a providing user 22, without the need for a user to request access to the asset.

In accordance with certain aspects, where a digital asset 12 is available for distribution, the asset may be requested by another user 14. Examples of digital assets include, but are not limited to: entire applications, demo applications, or features that can be utilized in a specific application. The rights to such assets may be granted with specific limitations, including but not limited to: selected rights out of a bundle of user rights, including the right to use an asset but not the right to transfer that asset; a limited time duration of the transfer (e.g., 1 day, 1 week, etc.); or limited field of use of rights, e.g., rights may be applicable across several titles but transfer may be applicable to a selected subset of titles. As a more particular example of the restriction of rights that are applicable across titles, consider the case of a video game asset in the form of a vehicle.

The providing user may have rights to use the vehicle in one game title, e.g., a racing game, and also in a second video game title, e.g., an action adventure video game from the same publisher. The providing user may wish to allow transfer of rights to use the vehicle in the action-adventure game but not the racing game.

In the present example, a providing user is not able to select a user to which an application asset is delivered, and the asset may only be granted after receiving a request for said available asset. In accordance with certain aspects, when a providing user has assets 12 that are available for distribution, a user will be provided with a list of assets that are available for use upon request 20. In this example, a user would select an available asset and send a request for use of that asset to the providing user's client device 22. In alternative implementations, a form of payment or credit could be required in order for the requesting user to be granted access rights to the asset 24. Examples of types of credit include, but are not limited to, forms of global currency, point or credit systems utilized by the client device platform network, or application-specific currency. In accordance with certain embodiments, varying amounts of credit could be redeemed for respectively varying durations of access rights to an asset. In still other alternative implementations, by way of example and not by way of limitation, credit may be automatically granted to a user upon the purchase of a client device or establishment of a client device profile, or may be earned by purchasing an application or completing in-application tasks in the present application or legacy application titles.

In accordance with certain aspects, once the providing user's client device receives a request for an asset, access rights to that asset would be granted to the requesting user 26. In certain embodiments, these access rights would be granted indefinitely. In this example, however, the requesting user is be granted the access rights for a limited duration of time (e.g. 1 day, 1 week, etc.) 32, and the providing user is required to wait until the time period granted to the requesting user expires before the providing user regains the access rights to the asset. In alternative implementations, the providing user would be able to relinquish the access rights of a requesting user at any time 38. Assuming, by way of example, and not by way of limitation, that in such an implementation, a credit or payment had been exchanged for the right of access to an asset, the requesting user could be refunded the portion of credit redeemed to receive asset access rights for the specific time period in relation to the proportion of asset utilization time remaining before the access right was revoked.

In the present example, once the requesting user's asset access rights expire, those asset access rights will be returned to the providing user 34. In accordance with certain embodiments, the list of a providing user's available assets may only be available to a user who appears on the providing user's “friends” list. In alternative embodiments, the list would be publicly available through the client device platform network. In still other alternative embodiments, the list would only be available only to those users who have formed a user group in accordance with a feature of a specific application. Additionally, alternative embodiments may allow the providing user to create a list of those assets that the user wishes to relinquish access to, and these lists may be provided over the client device platform network or over a social media network.

In some implementations, multiple users, including perhaps the providing user, could utilize a providing user's asset. In an alternative embodiment, a providing user may receive a reward for sharing an asset or having a certain number of users request an asset. By way of example, and not by way of limitation, the reward could be an identifier (e.g., an achievement or a trophy) linked to the user's profile. In an alternative embodiment, wherein credit is required for the exchange of an asset, a providing user could be rewarded monetarily, based on the number of users who acquire access rights to a user's asset or go on to purchase the asset for their own use after relinquishing access rights the providing user's asset.

It is emphasized that the example technique depicted in FIG. 1 is provided for purposes of illustration only, in order to highlight certain aspects of the present disclosure. In practice, implementations of the present disclosure may factor in additional or alternative considerations not depicted by the example of FIG. 1, and may be more complex than the simplified scheme depicted in FIG. 1.

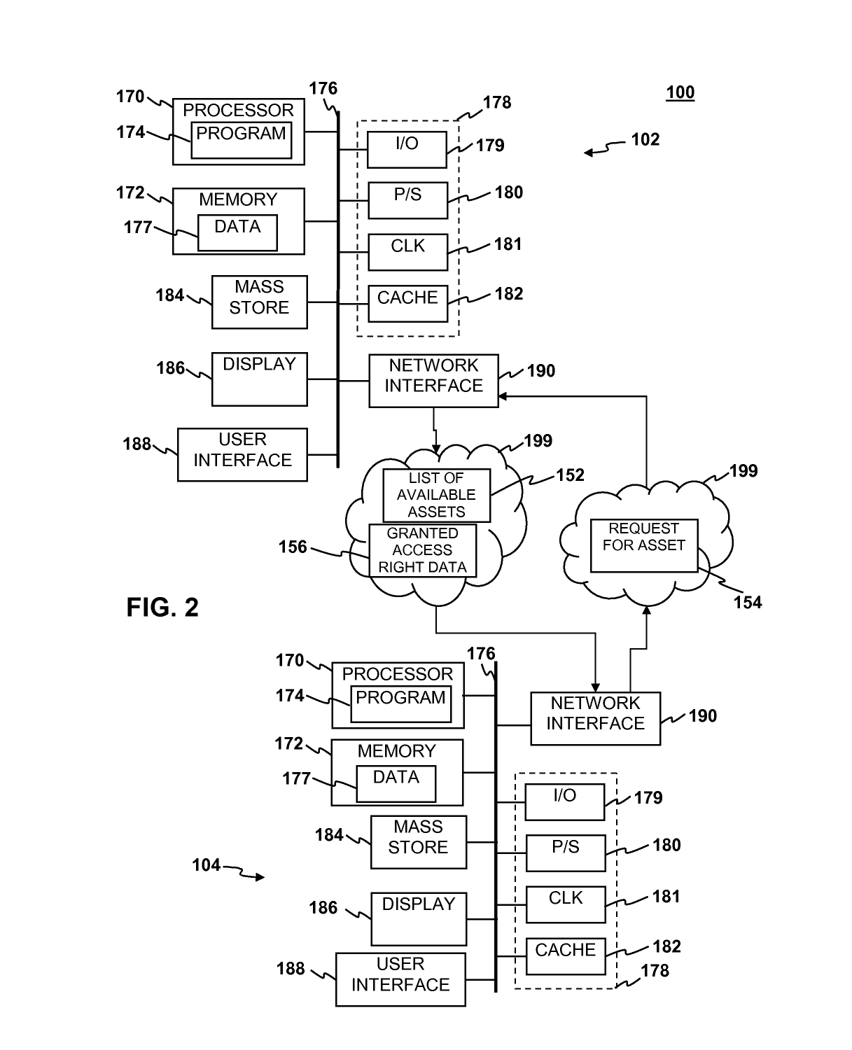

Certain implementations of aspects of the present disclosure include systems configured for asset management. By way of example, and not by way of limitation, FIG. 2 depicts a distributed computing system that includes two devices 102 and 104, and the computing systems 102 and 104 are configured to transfer data over a network in accordance with certain aspects of the present disclosure. In certain implementations, the device 102 may be configured to execute instructions that have one or more aspects in common with those described with respect to FIG. 1 and/or FIG. 3. In certain implementations, the device 104 may be configured to execute instructions that have one or more aspects in common with one or more of those described above with respect to FIG. 1 or below with respect to FIG. 4. Either or both the devices 102 and 104 may be configured with suitable software and/or hardware to implement various aspects of the methods described herein. Either or both the devices 102 and 104 may be a server, an embedded system, mobile phone, personal computer, laptop computer, tablet computer, portable game device, workstation, game console, wearable device such as a smart watch, and the like.

In accordance with certain implementations, the device 102 may be a client device utilized by a providing user, and the device 104 may be a client device utilized by a requesting user. The client device 102 may be configured to provide a list of available digital assets 152 to the requesting user's client device 104 over a network 199 using an internet connection. The list 152 may identify the digital assets and the specific rights that are available for transfer for each asset on the list.

Either of the devices 102 and 104 may include one or more processor units 170, which may be configured according to well-known architectures, such as, e.g., single-core, dual-core, quad-core, multi-core, processor-coprocessor, cell processor, and the like. Either of the devices 102 and 104 may also include one or more memory units 172 (e.g., RAM, DRAM, ROM, and the like). The processor unit 170 may execute one or more programs 174, which may be stored in the memory 172, and the processor 170 may be operatively coupled to the memory 172, e.g., by accessing the memory via a data bus 176. The memory unit 172 may include data 177, and the processor unit 170 may utilize the data 177 in implementing the program 174. The data 177 for either of the systems 102 and 104 may include, e.g., a request for an asset 154 transmitted from the client device 102 to the client device 104, and a list of available assets 152 or granted access right data 156 from the client device 104 to the client device 102 or vice versa according to various aspects of the present disclosure. The program 174 may include optionally instructions that, when executed by a processor, perform one or more operations associated with providing a list of available assets 152, requesting an available asset 154, or granting a requesting user the access right data requested 156 such as, e.g., a method having one or more features in common with the methods of FIGS. 1, 3, and/or 4. For example, the program 174 of the client 102 may include instructions that, when executed by the processor 170, cause the device to send data to the at least one recipient device 104 and/or provide granted access rights 156 in response to a request for an asset 154 from the client device 104, in accordance with aspects of the server side of the method depicted in FIG. 1 and/or the sending of asset access rights. The program 174 of the client device 104 may include instructions that, when executed by the processor 170, cause the client device request access rights to an asset 154 from a list of available assets 152 that can then be provided by the client device 102.

In some implementations, the request 154 may include a “token” in the form of specially configured code or data that another user or intermediary server could use to recognize that the requesting user is permitted to request a transfer of rights. The token may define how long the asset can be borrowed, which may be in terms of a total elapsed time from grant of access or a total amount of time using the asset. The token may be either provided to all users, who may use it to borrow assets from friends. Alternatively, tokens may be purchased through an online intermediary server. By way of example, and not by way of limitation, when rights to a digital asset are borrowed, the original owner cannot exercise those rights. In some implementations, the original owner may retain an ability to terminate the borrowing at any time. In such a case, the token may still have remaining time that the requesting user can use on another occasion.

Either of the devices 102 and 104 may also include well-known support circuits 178, such as input/output (I/O) circuits 179, power supplies (P/S) 180, a clock (CLK) 181, and cache 182, which may communicate with other components of the system, e.g., via the bus 176. Either of the devices 102 and 104 may optionally include a mass storage device 184 such as a disk drive, CD-ROM drive, tape drive, flash memory, or the like, and the mass storage device 184 may store programs and/or data. Either of the devices 102 and 104 may also optionally include a display unit 186. The display unit 186 may be in the form of a cathode ray tube (CRT), flat panel screen, touch screen, or other device that displays text, numerals, graphical symbols, or other visual objects. Either of the devices 102 and 104 may also include a user interface 188 to facilitate interaction between the device 102/104 and a user. The user interface 188 may include a keyboard, mouse, light pen, game control pad, touch interface, or other device. The user interface may also include an audio I/O device, such as a speaker and/or microphone.

A user may interact either of the computer systems through the user interface 188. By way of example, the server may 102 may be a cloud gaming server, and the client device 104 may be a cloud gaming client, and a video game user may interact with a video game executed by the server 102 and streamed to the client 104 through the user interface 188. Portions of the user interface 188 may include a graphical user interface (GUI) that can be displayed on the display unit 186 in order to facilitate user interaction with the system 102/104. The system 102/104 may include a network interface 190, configured to enable the use of Wi-Fi, an Ethernet port, or other communication methods. The network interface 190 may incorporate suitable hardware, software, firmware or some combination thereof to facilitate communication via a telecommunications network, and may support data transport using an unreliable protocol in accordance with certain aspects of the present disclosure. The network interface 190 may be configured to implement wired or wireless communication over local area networks and wide area networks such as the Internet. Either of the devices 102 and 104 may send and receive data and/or requests for files via one or more data packets 199 over a network.

As shown in FIG. 3, a set of providing user device instructions 370 may be implemented, e.g., by the providing user device 102. The providing user device instructions 370 may be formed on a nontransitory computer readable medium such as the memory 172 or the mass storage device 184. The providing user device instructions 370 may also be part of the process control program 174. As indicated at 374 the providing user device instructions 370 may include instructions for compiling a list of available assets 152 to be sent to one or more client devices 104 over a network. The instructions 370 may include instructions 374 for providing the list of available assets 152 to the another client device, for example, over the client device platform network. Thereafter, at 376 the instructions may include instructions for receiving a request for an available asset 154 and subsequently, at 378 may include instructions for delivering granted access rights of the available asset 156 to the requesting user device 104.

As shown in FIG. 4, a set of requesting user device instructions 480 may be implemented, e.g., by the requesting user device 104. The server instructions 480 may be formed on a nontransitory computer readable medium such as the memory 172 or the mass storage device 184. The server instructions 480 may also be part of the process control program 174. As indicated at 482, the instructions 480 may include instructions for receiving a list of available assets 152 from the providing user device 102, for example, over the client device platform network. Thereafter, at 484, the instructions may include instructions for delivering a request for an available asset 154 from the requesting user device 104 to the providing user device 102. Thereafter, at 486, the instructions may include instructions for receiving the access rights of the available asset 156 to the requesting user device 104. Furthermore, at 488, the requesting user device may include instructions for executing the access rights of the available asset, including, but not limited to, downloading any applications or application features necessary to run the requested asset.

The above components may be implemented in hardware, software, firmware, or some combination thereof.

The example, described above with respect to FIG. 2, FIG. 3, and FIG. 4 may be described as a “peer-to-peer” implementation in which rights are transferred directly between two or more user's devices. However, aspects of the present disclosure are not limited to such implementations. According to certain aspects of the present disclosure, the transfer of digital rights may take place through an intermediary, such as an online application server. With the increased use of cloud computing for access to digital services it is possible for the providing user and the requesting user to have accounts that provide them access to their respective digital assets. In such a situation, the transfer of access rights may take place using such a server as an intermediary between the providing and requesting users.

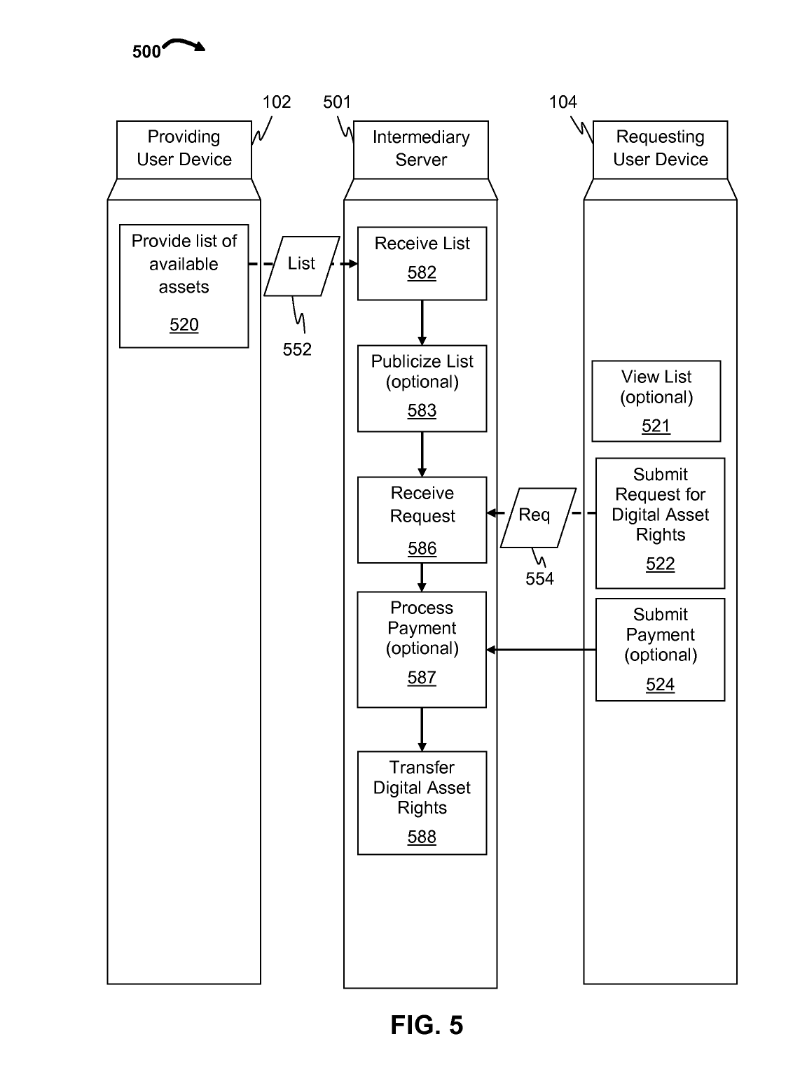

By way of example, and not by way of limitation, FIG. 5 illustrates a method 500 for processing transfer of rights to digital assents on an intermediary server 501 according to aspects of the present disclosure. The dotted arrows represent data being delivered over a network. Rectangular boxes represent processing steps, and the parallelograms represent the various forms of data being transferred. The providing user may have certain rights to one or more digital assets that can be accessed through the providing user's device 102.

In some implementations, the digital rights in question may be partly under the control of the operator of the intermediary server 104. For example, an online video game company may sell video games that can be played over the network 199 using the devices 102, 104. As users play the games they can obtain rewards or acquire digital assets within the context of the game. Such assets may include vehicles, game currency, clothing, weapons, specials powers that can be used within the context of one or more games. By facilitating transfer of digital rights via the intermediary server 104, the operator can provide an environment for transfer of rights to underlying digital assets in an orderly manner.

Initially, the providing user device 102 provides a list 552 of digital assets that are available for distribution to the intermediary server 501 over the network as indicated at 520. The list 552 may include the information described above, e.g., the assets and corresponding digital rights that are available for distribution. Preferably, the information included in the list 552 should describe the assets and corresponding rights in as much detail as possible. This is preferable because even though the assets on the list may be the same as those acquired by the providing user, not necessarily all of rights associated with those assets may be available for transfer. Although the providing user may be able to select the rights to be made available, the intermediary server 104 could place restrictions on the rights that the user may select. This may be done at the request of a person or entity that provided the digital assets to the providing user.

By way of example, and not by way of limitation, the list 552 may include a written description of the digital assets that are being made available, pictures of the assets, game play that display achievements earned or user generated content, statistics stored in a save file, a video overview of the package, or any similar disclosures, or any combination thereof.

Additionally, the list 552 may optionally include an asking price for specific assets or rights on the list. The price need not be in currency but may in the form of an offer to barter for rights to other assets. The intermediary server 501 may receive the list 552 from the providing user's device 102, as indicated at 582. The intermediary server 501 server 104 may optionally publicize the information included in the list 552, as indicated at 583, e.g., by posting it to a digital bulletin board that other users may peruse.

By way of example, and not by way of limitation, the list may be publicized in a searchable database that stores all lists for rights to digital assets currently being made available for transfer. Additionally, the intermediary server 501 may generate a URL that directs visitors directly to the database. By way of example, and not by way of limitation, the list 552 be publicized by posting the URL on a social media site, such as, but not limited to, Facebook, Twitter, or Google+ and YouTube or any other social media asset aggregator.

A requesting user may view the list 552 through the requesting user's device 104, as indicated at 521. The requesting user may submit a request 554 for transfer of selected digital asset rights on the list as indicated at 522. The request 554 may include information identifying the assets and digital rights on the list 552 for which transfer is desired. By way of example and not by way of limitation, the request 554 may be in the form of one or more data packets delivered to the intermediary server 501 over the network. In some implementations, the request 554 may include a “token” in the form of specially configured code or data that the intermediary server 501 may use to determine whether the requesting user is permitted to request a transfer of rights. The token may define how long the asset can be borrowed, which may be in terms of a total elapsed time from grant of access or a total amount of time using the asset.

The intermediary server 501 may receive the request 554, as indicated at 586 and implement the transfer of digital rights between the providing user and the requesting user, as indicated at 588. The intermediary server 501 may implement the transfer, e.g., by transferring code and or data for a particular asset or rights to a particular asset from the providing user's account to the requesting user's account to reflect the transfer. Alternatively, the intermediary server may simply change information identifying an “owner” or “authorized user” of a digital asset in a data file for the asset so that, e.g., the requesting user may access the asset but the providing user cannot. Alternatively, the intermediary server may add the requesting user to a list of “authorized users” of the digital asset, and remove it after some predetermined time.

The requesting user may optionally submit payment for the transfer, as indicated at 524 and the intermediary server 501 may optionally process the payment, as indicated at 587. The intermediary server 501 may process the payment, e.g., by debiting an account associated with the requesting user and crediting an account of the providing user by an agreed upon amount. The intermediary server 501 may collect a portion of this amount as a fee for the rights transfer and/or payment processing.

Aspects of the present disclosure allow users to exchange rights to digital assets via networked devices in creative ways. For example, in some implementations, users who share assets can get or share rewards for doing so. For example a providing user may lend a race car to a requesting user. If the requesting user upgrades the race car, all the upgrade options are unlocked for the providing user when it is returned.

In other implementations, a providing user may share assets instantly to a group of a controlled size or affinity level. This allows users to share a new game or in-game assets with the group. By way of example, and not by way of limitation, a user may have early access to a new Battlefield and purchases a massive armored mechanized vehicle. The user may be permitted to share the vehicle with First Person Shooter buddies only.

Other implementations could allow large scale lending of assets. In such implementations a providing user could purchase a large number of assets to share. These assets may be loaned to requesting users. The providing user may enable the requesting users to lend out the loaned assets to still other users without permission from the providing user. The providing user could retain a virtual “closet” of assets that other users can peruse and choose what they want for any game.

While the above is a complete description of the preferred embodiment of the present invention, it is possible to use various alternatives, modifications and equivalents. Therefore, the scope of the present invention should be determined not with reference to the above description but should, instead, be determined with reference to the appended claims, along with their full scope of equivalents. Any feature described herein, whether preferred or not, may be combined with any other feature described herein, whether preferred or not. In the claims that follow, the indefinite article “a”, or “an” refers to a quantity of one or more of the item following the article, except where expressly stated otherwise. The appended claims are not to be interpreted as including means-plus-function limitations, unless such a limitation is explicitly recited in a given claim using the phrase “means for.”

What is claimed is:

1. On a client device platform configured to operate on a network, a method for sharing assets comprising:
a) providing a user with a list of assets that can be borrowed from a providing user;
b) allowing a user to request the use of an asset; and
c) transferring certain asset rights from the providing user to the requesting user.

2. The method of claim 1, wherein the list is comprised of applications that can be utilized by the requesting user.

3. The method of claim 2, wherein the application is a demo application.

4. The method of claim 1, wherein the list is comprised of assets that can be utilized within an application.

5. The method of claim 1, wherein access to the list is restricted to those users who appear on the friends list of the providing user.

6. The method of claim 1, wherein access to the list is restricted to those users who have formed a group within an application.

7. The method of claim 1, wherein the providing user can list specific assets to be borrowed.

8. The method of claim 7, wherein a user can share a list of borrowable assets over a social media network.

9. The method of claim 7, wherein a user can share a list of borrowable assets over the client device platform network.

10. The method of claim 1, wherein only a single requesting user may utilize a listed asset.

11. The method of claim 1, wherein multiple users may utilize a listed asset.

12. The method of claim 1, wherein a requesting user is only granted asset access rights provided that user has sufficient credit to borrow the listed asset.

13. The method of claim 12, wherein the credit required to borrow an asset is a form of global currency.

14. The method of claim 12, wherein the credit required to borrow an asset is a form of credit utilized by the client device platform network.

15. The method of claim 14, wherein the credit is automatically granted to the user.

16. The method of claim 14, wherein the credit is earned by purchasing an application.

17. The method of claim 14, wherein the credit is earned by completing in-application tasks.

18. The method of claim 12, wherein the credit required to borrow an asset is a form of in-application currency.

19. The method of claim 18, wherein in-application currency is given to a user upon the purchase of an application.

20. The method of claim 19, wherein additional in-application currency can be earned via the purchase of legacy applications.

21. The method of claim 18, wherein the currency is earned by completing in-application tasks.

22. The method of claim 21, wherein additional currency can be earned via completion of in-application tasks completed in legacy applications.

23. The method of claim 1, wherein the rights transferred include only a subset of the rights granted to the providing user.

24. The method of claim 23, wherein the subset of rights includes a right to use an asset but not the right to transfer the application to another user.

25. The method of claim 1, wherein the providing user may not utilize a borrowed asset until the requesting user has relinquished access rights.

26. The method of claim 1, wherein the providing user may revoke the access rights of a requesting user at will.

27. The method of claim 1, wherein asset access rights are granted for a limited period of time, after which rights revert to the providing user.

28. The method of claim 27, wherein a requesting user may be granted asset access rights for various periods of time by redeeming respectively varying amounts of credit.

29. The method of claim 28, wherein the providing user may revoke the access rights of a requesting user at will.

30. The method of claim 29, wherein a user is refunded the portion of credit redeemed to receive asset access rights for a specific time period, in relation to the proportion of asset utilization time remaining before the access right was revoked.

31. The method of claim 1, wherein the rights transferred include a limited field of use of rights, such that rights transferred are applicable across several applications but transfer may be applicable to a selected subset of applications.

32. The method of claim 1, wherein a providing user can grant asset access rights to another user without first receiving a request for that asset.

33. The method of claim 1, wherein a providing user receives a reward if an asset is borrowed from the providing user's list.

34. A system comprising:
a processor, and
a memory coupled to the processor;
wherein the processor is configured to perform a method for sharing assets, the method comprising:
a) providing a user with a list of assets that can be borrowed from a providing user;
b) allowing a user to request the use of an asset; and
c) transferring certain asset rights from the providing user to the requesting user.

35. A non-transitory computer readable medium having processor-executable instructions embodied therein, wherein execution of the instructions by a processor cause the processor to implement a method for sharing assets, the method comprising:
a) providing a user with a list of assets that can be borrowed from a providing user;
b) allowing a user to request the use of an asset; and
c) transferring certain asset rights from the providing user to the requesting user.

36. On a client device platform configured to operate on a network, a method for sharing assets comprising:
a) providing a user with a list of assets that can be distributed to other users;
b) allowing the providing user to distribute access rights for those assets to another user.

37. The method of claim 36, wherein asset access rights are granted for a limited period of time, after which rights revert to the providing user.

38. The method of claim 36, wherein the providing user may not utilize a distributed asset until the receiving user has relinquished access rights.
